(19) United States
(12) Patent Application Publication
(10) Pub. No.: US 2009/0033142 A1
(43) Pub. Date: Feb. 5, 2009

(54) POWERED MOTOR VEHICLE REAR AXLE OF A TWIST-BEAM AXLE TYPE

(75) Inventors: Gerd BITZ, Mainz (DE); Dirk EHRLICH, Bodenheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/178,459

(22) Filed: Jul. 23, 2008

(30) Foreign Application Priority Data
Aug. 1, 2007 (DE) 102007036080.2

(51) Int. Cl. B60B 35/12

(52) U.S. Cl. 301/127

(57) ABSTRACT

A powered motor vehicle rear axle 10 is provided that can be coupled with a motor vehicle drive train. The powered motor vehicle rear axle is configured as twist-beam rear axle with two wheel carrying resistant trailing arms that are elastically linked to the motor vehicle structure and a bending resistant, but torsion flexible cross member. Here each of the trailing arms swings around at least one swivel axle. Over its entire length the cross member has a one-piece pipe profile or an open profile. Here it is separate from the swivel axles as well as from the wheel centers when viewed lengthwise from of the motor vehicle. In the area of its both ends the cross member is welded to the trailing arms 12. The cross member is, in particular, generally bent upwards to make space for the installation of at least one module allocated for the drive train, for example for the installation of a drive shaft and a rear axle differential.

### CROSS-REFERENCE TO RELATED APPLICATION

This application claims priority to German Patent Application No. 102007036080.2, filed Aug. 1, 2007, which is incorporated herein by reference in its entirety.

### TECHNICAL FIELD

The invention generally relates to a powered motor vehicle rear axle, which can be coupled with a motor vehicle drive train. It also generally relates to a motor vehicle with such a powered motor vehicle rear axle.

### BACKGROUND

Existing powered motor vehicle rear axles have a large number of sheets resulting in relatively high expenditure in installation and welding. Additionally, the endurance limit of welded sheets is critical. Axles with an edged torsion profile have already been suggested, whereby the edged torsion profile has not only been used with four-wheel vehicles, but also with vehicles without four-wheel drive. However, all these axles have the large number of sheets which again leads to the aforementioned disadvantages.

Accordingly, it is at least one object to minimize the cost of rear axle construction and the cost for installation and welding and also improve the endurance limit of powered motor vehicle rear axels. In addition, other objects, desirable features, and characteristics will become apparent from the subsequent summary and detailed description and the appended claims, taken in conjunction with the accompanying drawings and this background.

### SUMMARY

In terms of the powered motor vehicle rear axle this task is solved according to an embodiment. The powered rear axle for a motor vehicle, which can be coupled with a motor vehicle power train, is configured as twist-beam rear axle with two wheel carrying rigid trailing arms that are elastically linked at the motor vehicle structure and a bending resistant but torsion flexible cross member. Here each of the trailing arms swings at least around one swivel axle. Over its entire length the cross member consists, for instance, of a one-piece pipe pro-file or an open profile. The cross member is located in front of the wheel centers (viewed lengthwise from of the motor vehicle) and distanced from the swivel axles. Moreover, in the area of its two ends the cross member is welded to the trailing arms. To make space for the installation of at least on module allocated for the drive train the cross member is, in particular, generally bent upwards.

The outcome of this solution is a particularly cheap powered motor vehicle rear axle. Due at least in part to the cross member generally bent upwards, space is created for the installation of the module allocated for the drive train. Here the cross member can, in particular, be bent in such a way that sufficient space is created to install a drive shaft and a rear axle differential. In other words, the powered motor vehicle rear axle according to an embodiment is a twist-beam rear axle where the cross member, which is welded with the trailing arms, sits, in contrast to common rigid axles, in front of the wheel center and takes up a substantial amount, if not all of the high and lateral moments of a torque and thus simultaneously acts as a stabilizer. Preferably, the cross member is bend upwards at least in its middle region (viewed lengthwise from of the brace) according to a prescribed amount.

According to a preferred practical embodiment of the powered motor vehicle rear axle, the cross member possesses at each of its two ends, a relatively torsion resistant cross section and in the middle region a relatively torsion flexible U-, V-, L-, X- or similar cross section with at least one double or single wall profile handle. Here the crossover region between the torsion resistant and the torsion flexible cross section is preferably designed in a smooth way.

It is particularly advantageous if the cross section of the junction between the respective trailing arm and the cross member has a symmetrical rotation form which allows an axial turning of the cross member prior to the welding of the connection. Due to this symmetrical rotation form and independent on the form of the cross section of the cross member in the torsion area the cross member can be turned as desired prior to the welding to the trailing arms. The length of the shear center in the torsion area can thus be changed as desired even during the serial production.

With reduced production efforts it is possible to satisfy various requirements in terms of the characteristics to be fulfilled, particularly the change of the hitch and toe-in with reciprocal deflection and/or the resonant steering behavior of the rear axle when cornering. Then it is also possible to achieve higher durability and load capacity.

According to a preferred embodiment, the trailing arms are designed as bending and torsion resistant cast parts. This allows integrating all necessary parts such as the wheel mount plate, spring seat, the eye to attach the shock absorber and, possibly, a stabilizer, a holder for the lying or standing damping bushes and other chassis parts into the trailing arm. To increase the stability and/or to reduce the weight the trailing arms can also be cast from steel or light alloy.

To connect the cross member with the trailing arms they are connected with the respective end of the cross member. Thus the trailing arms are provided with an attachment piece whose cross section can preferably be round or oval.

A particularly advantageous design occurs if the attachment piece is designed as a tube and its wall thickness at the junction with the cross member equals the wall thickness of the respective end of the cross member. This type of design of the attachment piece is particularly suitable for welding procedures according to the magnet-arc welding technique. The wall thickness of the pipe profile end and attachment piece, which should be substantially the same, can be changed to a wall thickness which is suitable for the welding either by mechanically reworking the attachment piece or by deforming the pipe profile end (i.e., the end of the cross member).

As an alternative, the outer perimeter and/or diameter of the attachment piece can be similar or somewhat smaller than the inner perimeter and/or diameter of the cross member built by a pipe profile. For a connection with the trailing arm, the profile pipe end can simply be put onto the attachment piece and, thus, exactly be positioned before it is welded to the attachment piece at its front face.

According to an additional alternative embodiment, it is possible to connect each trailing arm with the respective end of the cross member built by a pipe profile. Here it can be put into an opening in the respective attachment piece and welded to the front face of the attachment piece.

The load capacity of the powered motor vehicle rear axle of the twist-beam rear axle system according to the embodiments can be increased quite easily by using a more resistant cross member with a larger cross section area and/or form in the torsion region. Such a cross member can be manufactured according to already known procedures, such as the internal high pressure deformation technique. Here only the diameter of the raw material is extended in the torsion region before it is deformed into a U-, V-, L-, X- or similar cross section. Thus, it is possible to particularly influence the steadiness and the torsion rate of the pipe profile without changing the junction to the trailing arms.

To distribute occurring forces and torsion stresses equally in the pipe profile, the crossover regions between the torsion resistant and torsion flexible cross section are ideally formed in a way that the torsional resisting torque decreases continuously from the torsion resistant to the torsion flexible cross section. Because the torsional resisting torque depends on the cross section surface and geometry, it is possible to achieve such a course of the torsion resisting torque by means of a continuous deformation of the pipe pro-file with a defined change of the cross section.

The production of the pipe profile according to an embodiment is relatively easy and cheap since a common pipe can be used as raw material. Prior to the deformation, it is possible to insert special molded parts into this pipe for the torsion region and the crossover regions, in order to reach the de-sired cross section of the profile. Subsequently, the pipe can mechanically be formed into the prescribed cross section with an appropriate stamp. After the removal of the molded parts, the pipe can be welded with the trailing arms in a welding fixture.

The trailing arms can, for example, swing around an axle which is at least (mainly) vertical in relation to the longitudinal direction of the motor vehicle (i.e., in particular a vertical transverse axle). With an alternative functional embodiment, each trailing arm swings around an axle which is diagonally aligned in relation to a transverse axle that, in turn, is vertical in relation to the longitudinal direction of the motor vehicle.

Thus, a relatively inexpensive powered motor vehicle rear axle of a twist-beam rear axle type with a cross member that consists of a one-piece pipe profile is specified. This cross member is generally bent upwards to make space for the installation of at least on module allocated for the drive train, such as for the installation of a drive shaft and a rear axle differential. While the torsion profile is made of one single pipe, the trailing arms can be designed as cast link. The torsion profile and/or the cross member can have a round, closed cross section particularly at the edge. In the middle section the pipe can, for example, be deformed to a U-form. Due to package reasons, the torsion profile in the middle section is bent upwards according to a prescribed amount. To link the trailing arms even or inclined bearing bushes can be used. If possible, the body roll center can be hoisted. With different pipe strengths and cross sections the axle can easily be adjusted to various requirements (e.g., motor vehicle weight, base/sport/OPC suspension, etc.) without having to change the expensive trailing arms.

### BRIEF DESCRIPTION OF THE DRAWINGS

The embodiments will hereinafter be described in conjunction with the following drawing

FIG. 1 showing a perspective view of an embodiment of the powered motor vehicle rear axle, which can be coupled with the motor vehicle drive train.

### DETAILED DESCRIPTION

The following detailed description is merely exemplary in nature and is not intended to limit application and uses. Furthermore, there is no intention to be bound by any theory presented in the preceding summary and background or the following detailed description.

As it can be seen from the only figure the powered motor vehicle rear axle 10 is designed as a twist-beam rear axle with two wheel carrying resistant trailing arms 12 which are elastically linked to the motor vehicle structure and a bending resistant but torsion flexible cross member 14.

Here each trailing arm 12 swings around at least one swivel axle 16. Over its entire length the cross member 14 has a one-piece pipe profile or an open profile. It is separate from the swivel axles 16 and is configured in front of the wheel center when viewed lengthwise from of the motor vehicle. In the region of its both ends the cross member 14 is welded to the trailing arms 12.

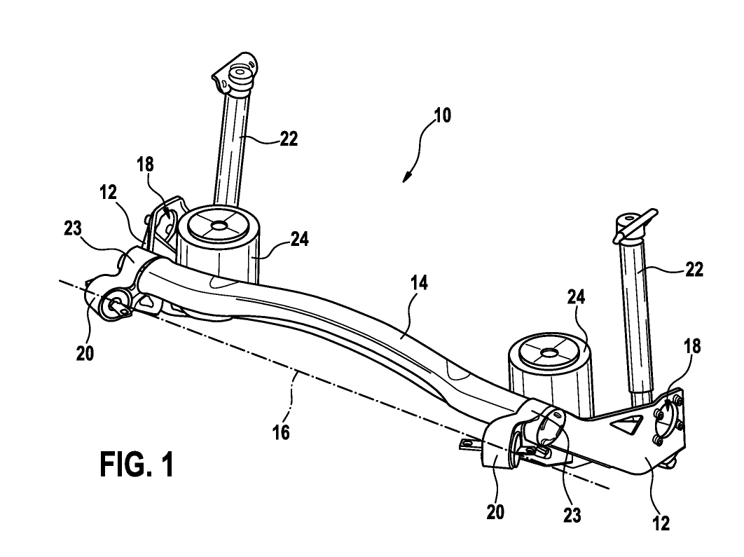

As it can be seen by means of FIG. 1, the cross member 14 is, in particular, generally bent upwards to make space for the installation of at least one module allocated for the drive train, for example for the installation of a drive shaft and a rear axle differential. Here the cross member 14 is at least in its middle section, when viewed lengthwise from of the rod, bent upwards by a prescribed amount.

In both ends, the each cross member 14 possesses a relatively torsion resistant cross section and in the middle section a relatively torsion flexible U-, V-, L-, X- or similar cross section with at least one double-walled profile handle. In the middle section this cross member 14 is thus significantly more torsion flexible than in the section of its both ends which have a relatively more torsion resistant cross section. The crossover region between the torsion resistant and the torsion cross section is smoothly formed.

At the rear end of the trailing arm 12 retainers 18 are provided for the connection with, in each case, one wheel carrier for bearing one wheel. At its front end, each trailing arm 12 is elastically linked via a joint 20 at the motor vehicle structure which is not depicted. Here the joints define the swivel axles 16 around which the trailing arms 12 swing.

With the execution example presented here the cross section of the junction has, between the respective trailing arm 12 and the cross member, a symmetrical rotation form which allows an axial turning of the cross member 14 prior to the welding of the connection. In particular, the trailing arms 12 can be configured as bending and torsion resistant cast parts.

For the connection with the respective ends of the cross member 14 the trailing arms 12 can be provided with an attachment piece 23 whose cross section can preferably be round or oval. Here, the respective attachment piece 23 can have a tubular design and, at the junction with the cross member 14, it can have a wall strength which is about the same as the wall strength of the relevant end of the cross member 14. Particularly in this case, the trailing arms 12 and/or their attachment pieces 23 can be connected with the ends of the cross section member 14 according to the magnet-arc welding technique.

Additionally, a design is imaginable in which the respective end of the cross member 14 is put onto the respective attachment piece 23 and is welded to the attachment piece 23 at the front face of the cross member 14 to connect the relevant trailing arm 12. For the connection with each trailing arm 12 it is also possible to put the respective end of the cross member 14 into an opening in the respective attachment piece 23 and to connect it at the front faces of the attachment piece 23.It is also possible to extend the wall strength of the cross member 14 at its two ends in relation to the wall strength in the torsion region (by deforming).

In principle, a design is imaginable where, prior to the de-forming into a U-, V-, L-, X- or similar cross section, the cross member 14 possesses a lower diameter than it has at its two ends in the torsion region.

Additionally, the cross member 14 can be deformed at the crossover regions between the torsion resistant and the torsion flexible cross section in such a way that the torsional resisting torque between the torsion resistant and the torsion flexible cross section progressively decreases. The only figure shows also the shock absorber 22 and the springs 24.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A powered rear axle for a motor vehicle that can be coupled with a motor vehicle power train, comprising:
a twisted beam axle with at least two stiff trailing arms that are elastically mounted to a structure of the motor vehicle, adapted to support two wheels, and adapted to swivel about at least one pivot axle;
a stiff torsion-soft cross member comprising a profile and separate from the at least one pivot axle and configured in front of centers of the two wheels, the cross stiff torsion-soft cross member welded at end regions to trailing arms and bent upwards for a space adapted to incorporate at least one module allocated for the motor vehicle power train.

2. The powered rear axle according to claim 1, wherein the cross member is configured to make a second space for incorporation of a flexible drive shaft and a rear axle differential.

3. The powered rear axle according to claim 1, wherein the cross member comprises an upward bend.

4. The powered rear axle according to claim 1, wherein the cross member comprises a relatively torsion-stiff cross-section on each end and in the middle region relatively torsion-soft cross-section with at least a single walled profile handle.

5. The powered rear axle according to claim 1, wherein a crossover region from the torsion-stiff cross-section to the torsion-soft section is substantially smooth.

6. The powered rear axle according to claim 1, wherein a cross-section of a connecting location between one of the trailing arms and the cross member has a symmetrical rotation form which allows an axial turning of the cross member before a welding of the connection location, wherein the trailing arms are provided with an attachment to connect a relevant end of the cross member.

7. The powered rear axle according to claim 6, wherein the attachment is substantially rounded.

8. The powered rear axle according to claim 6, wherein the attachment is pipe-shaped and has a wall strength at the connection location with the cross member that is substantially the same as a wall strength of the relevant end of the cross member.

9. The powered rear axle according to claim 1, wherein the trailing arms are welded with ends of the cross member profile.

10. The powered rear axle according to claim 1, wherein the relevant end of the cross member is placed in a recess and welded onto a face of the attachment.

11. The powered rear axle according to claim 1, wherein a wall strength of the cross member is enhanced through transformation, and before the transformation, the cross member in the torsion region has a bigger diameter than on both of its ends.

12. The powered rear axle according to claim 1, wherein the cross member has a first diameter in the torsion region that is less than a second diameter in both of its ends before its reshaping into a cross-section.

13. The powered rear axle for motor vehicle according to claim 1, wherein the trailing arms each swivel around an axle that is substantially perpendicular to a length of the motor vehicle.
